(19) United States
(12) Patent Application Publication
(10) Pub. No.: US 2026/0192778 A1
(43) Pub. Date: Jul. 9, 2026

(54) RAIN DETECTION USING SECONDARY FIELD OF VIEW CAMERA FOR DRIVER SAFETY SYSTEM

(71) Applicant: Magna Mirrors of America, Inc., Holland, MI (US)

(72) Inventors: Traian Miu, Oakville (CA); Gabriele Wayne Sabatini, Keswick (CA); J.R. Scott Mitchell, Newmarket (CA)

(21) Appl. No.: 19/437,411

(22) Filed: Dec. 31, 2025

Related U.S. Application Data
(60) Provisional application No. 63/741,622, filed on Jan. 3, 2025.

(51) Int. Cl. B60S 1/08; B60R 1/08; B60R 1/12; B60S 1/48

(52) U.S. Cl. CPC B60S 1/0844; B60R 1/088; B60R 1/12; B60S 1/482; B60S 1/485; B60R 2001/1253; B60R 2300/8053

(57) ABSTRACT

A vehicular rain sensing system includes an interior rearview mirror assembly having a mirror head that accommodates a mirror reflective element. A downward-viewing camera is accommodated by the mirror head and views within the interior cabin of the vehicle. The camera views through a portion of a windshield of the vehicle and views a portion of a driver region within the interior cabin of the vehicle. With the interior rearview mirror assembly mounted at the interior portion of the interior cabin of the vehicle, image data captured by the camera is processed for monitoring of the driver of the vehicle and for determining presence of moisture at the windshield. Responsive to determining presence of moisture at the windshield, the system controls operation of at least one of a windshield washer fluid spray pump and a windshield wiper motor of the vehicle.

### CROSS REFERENCE TO RELATED APPLICATION

The present application claims the filing benefits of U.S. provisional application Ser. No. 63/741,622, filed Jan. 3, 2025, which is hereby incorporated herein by reference in its entirety.

### FIELD OF THE INVENTION

The present disclosure relates generally to a detection system for a motor vehicle and, more particularly, to a detection system with rain sensing functionality, and a method of operating a detection system.

### BACKGROUND OF THE INVENTION

This section provides background information related to the present disclosure which is not necessarily prior art.

Modern vehicles typically include numerous sensors to provide functionality and convenience to drivers and passengers. For example, rain sensors may be used to detect rain on the windshield to cause various operations (e.g., turn on windshield wipers and/or control headlights). Yet, such sensors typically include dedicated emitter/receivers that add complexity and cost to the vehicle.

### SUMMARY OF THE INVENTION

An aspect of the present disclosure is to provide a detection system for a motor vehicle including a first camera having a first field of view encompassing at least a portion of a windshield of the motor vehicle. The detection system also includes a controller configured to process windshield image data of the windshield from the first camera to detect rain on the windshield.

For example, a vehicular rain sensing system includes an interior rearview mirror assembly having a mirror head that accommodates a mirror reflective element. A downward-viewing camera is accommodated by the mirror head and views within the interior cabin of the vehicle. The camera views a portion of a windshield of the vehicle and a portion of a driver region within the interior cabin of the vehicle. With the interior rearview mirror assembly mounted at the interior portion of the interior cabin of the vehicle, image data captured by the camera is processed for monitoring of the driver of the vehicle. Based on determining presence of moisture or debris at the windshield, the system controls operation of at least one of a windshield washer fluid spray pump and a windshield wiper motor of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of an example motor vehicle with an interior rearview mirror assembly according to aspects of the disclosure;

FIG. 2 is a perspective view of the rearview mirror assembly of FIG. 1 and illustrates a detection system incorporated therein according to aspects of the disclosure;

FIG. 3 is a cross-sectional view of a portion of the motor vehicle illustrating the detection system according to aspects of the disclosure;

FIG. 4 is a perspective view within the interior of the motor vehicle also illustrating the detection system according to aspects of the disclosure; and

FIG. 5 is a block diagram of the detection system according to aspects of the disclosure.

### DESCRIPTION OF THE PREFERRED EMBODIMENTS

In the following description, details are set forth to provide an understanding of the present disclosure. In some instances, certain circuits, structures and techniques have not been described or shown in detail in order not to obscure the disclosure.

In general, the present disclosure relates to a detection system of the type well-suited for use in many applications. More specifically, a detection system with rain sensing functionality. The detection system and corresponding method of operation of this disclosure will be described in conjunction with one or more example embodiments. However, the specific example embodiments disclosed are merely provided to describe the inventive concepts, features, advantages and objectives with sufficient clarity to permit those skilled in this art to understand and practice the disclosure.

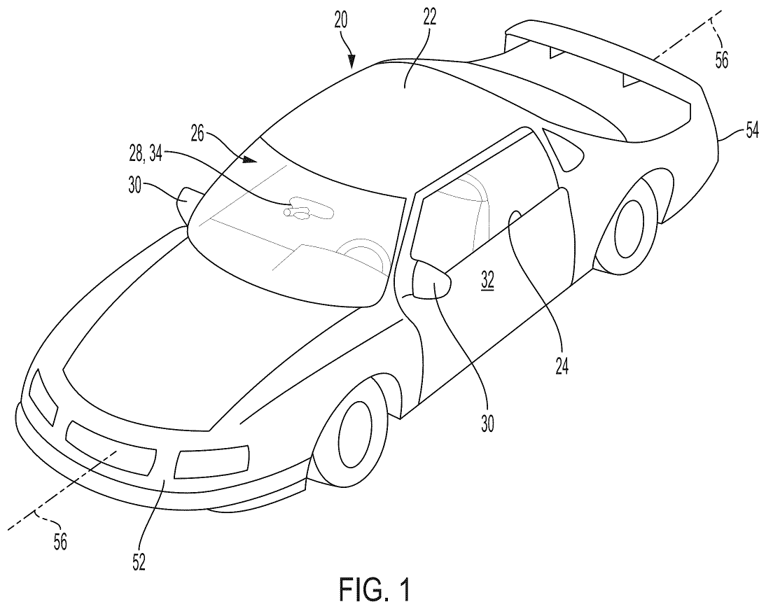

Referring initially to FIG. 1, an example motor vehicle 20 is shown to include an exterior 22 and an interior defining a cabin 24. The vehicle 20 includes a windshield 26 and an interior rearview mirror assembly 28 attached to an in-cabin or interior side of the windshield 26. Optionally, the interior rearview mirror assembly 28 is mounted to an interior portion of the interior cabin 24 of the vehicle 20 at or near the windshield 26, such as a headliner of the vehicle 20. The vehicle 20 may additionally include side mirrors 30 mounted to the exterior 22, such as on side doors 32 of the vehicle 20.

To improve safety and convenience, rain sensing may be employed. Such rain sensing is typically done using a dedicated system of emitter/receivers to detect rain on the windshield 26. For example, a rain-light sensor (not shown) is a combined device that detects both rain and ambient light to automate the operation of windshield wipers and headlights of the vehicle 20. Such a sensor may be located behind the interior rearview mirror assembly 28 on the windshield 26. For example, the rain-light sensor may be disposed at mounting structure of the interior rearview mirror assembly 28 so that the rain-light sensor is disposed at or adjacent the windshield, or the rain-light sensor may be disposed at a forward portion of the mirror head (i.e., in a forward direction of travel of the vehicle) so that the rain-light sensor faces the windshield and views or senses a portion of the windshield. The rain-light sensor may emit and detect infrared light to detect moisture on the windshield 26. Infrared light is emitted at a 45-degree angle and reflected back to the rain-light sensor. When raindrops are present, the light is scattered, reducing the amount of light reflected back. This triggers the wipers to activate for example. The rain-light sensor also measures ambient light levels to automatically switch the headlights on or off, enhancing visibility during low-light conditions. Nevertheless, such separate rain-light sensors increase vehicle complexity and cost.

In addition, or alternatively, there are systems that use a forward looking camera (e.g., that may also be used for advanced driver assistance systems (ADAS)) to detect rain, but these are typically unreliable since their field of view/focus is tuned for things in front of the vehicle 20 and not immediately next to the windshield 26, so any debris or rain on the windshield 26 may be judged improperly due to the debris or rain being out of focus to the camera. For example, the forward looking or forward viewing camera may be disposed at mounting structure of the interior rearview mirror assembly 28, at a windshield mounted electronics module of the vehicle, and the like, and view regions exterior of the vehicle 20 through the windshield 26. Furthermore, since the forward looking camera is positioned next to the windshield 26, the effective detection area is very small (e.g., 1 cm by 1 cm) meaning any rain would have to be positioned basically on the portion of the windshield 26 the size of the camera lens in order to be detected, making the detection area very small and not responsive until basically the entire windshield 26 is covered with rain/water; before the spaced droplets on the windshield 26 may trigger sensing the rain.

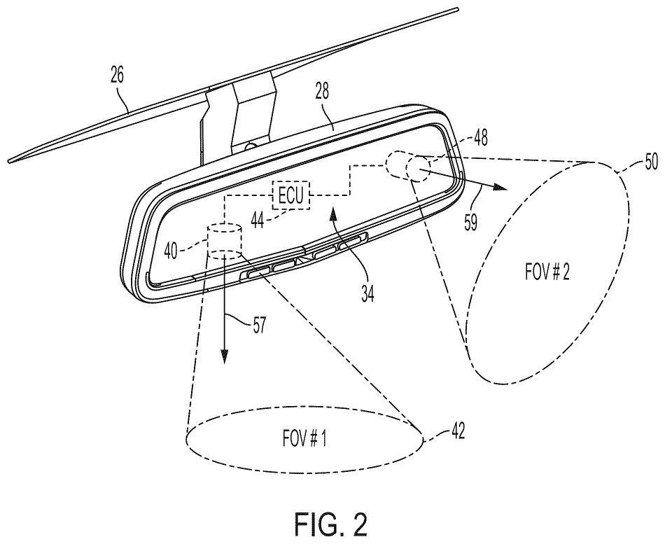

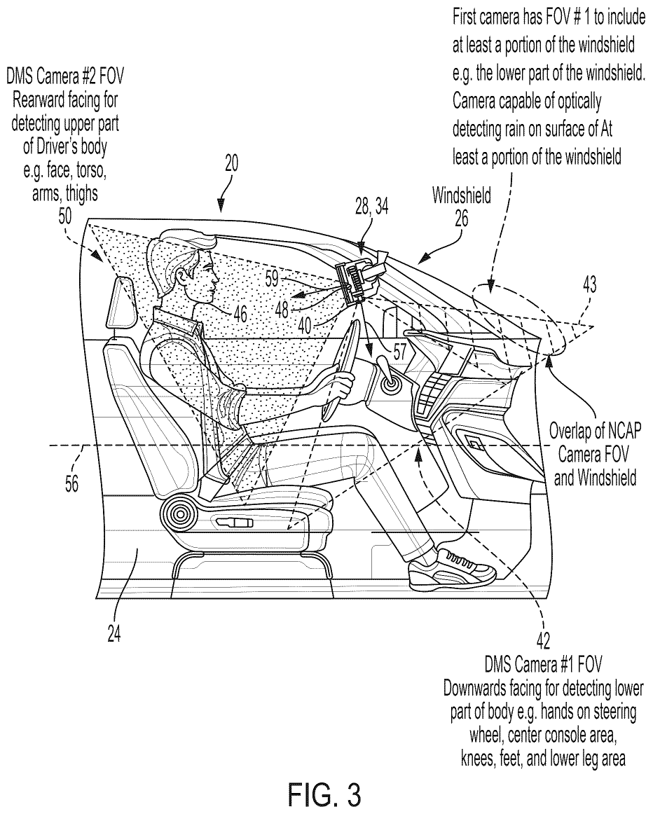

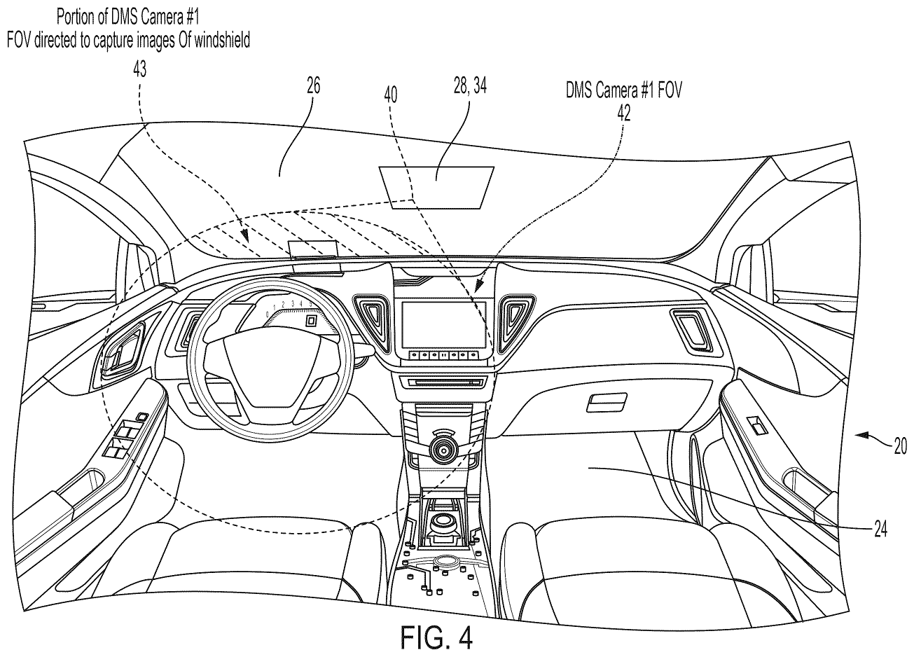

According to aspects of the disclosure, the vehicle 20 includes a detection system 34 disposed at or in the interior rearview mirror assembly 28 of the vehicle 20, as best shown in FIG. 2, which shows a perspective view of the interior rearview mirror assembly 28 and illustrates the detection system 34 (such as in the mirror head of the mirror assembly and behind the mirror reflective element, such as a prismatic mirror reflective element or an electro-optic or electrochromic mirror reflective element, and encased by the plastic mirror casing). In other words, the detection system 34 may be a combination interior rearview mirror assembly 28 integrated with sensing capability. FIG. 3 is a cross-sectional view of a portion of the motor vehicle 20 illustrating the detection system 34. FIG. 4 is a perspective view of the interior of the motor vehicle 20 also illustrating the detection system 34. By integrating the sensing with the interior rearview mirror assembly 28, the detection system 34 may be concealed within the interior rearview mirror assembly 28, while also providing a pre-existing mounting point at a vantage point within the cabin 24 to allow for sensing within the cabin 24, as well as zones exterior to the cabin 24. However, it should be understood that the detection system 34 could be separate from the interior rearview mirror assembly 28.

Still referring to FIGS. 2-4 and according to an aspect, the detection system includes a first camera 40 having a first field of view 42 encompassing at least a portion of a windshield 26 of the motor vehicle 20 (e.g., a lower part or lower region of the windshield 26, indicated as 43 in FIGS. 3 and 4). Thus, the first camera 40 is capable of optically detecting rain on a surface of at least a portion of the windshield 26. The detection system 34 also includes a controller or electronic control unit (ECU) 44 configured to process image data representative of the windshield 26 from the first camera 40 to detect rain on the windshield 26. That is, the ECU 44 includes electronic circuitry and associated software, including at least an image processor for processing captured image data and/or a data processor for processing captured sensor data.

In addition to the first field of view 42 of the first camera 40 including at least a portion of the windshield 26, the first field of view 42 of the first camera 40 additionally encompasses at least a portion of a body of a driver 46 of the motor vehicle 20. So, the detection system 34 can comprise a DSM (Driver Safety Monitoring) system which involves monitoring of a lower part of the driver 46 (e.g., the feet/foot well of the vehicle 20 and/or hand positions of the driver 46, such as at a steering wheel or center stack of the vehicle 20). For example, the first camera 40 may be disposed at a lower edge region of the mirror head or mirror casing of the interior rearview mirror assembly 28 and viewing in a generally downward direction from the mirror head. The first camera 40 may have a sufficiently wide field of view so as to view at least forward in a direction of travel of the vehicle from the mirror head toward the windshield 26 and to view at least rearward from the mirror head toward the driver 46 of the vehicle 20. For example, the first camera 40 may comprise a wide-view lens or fisheye lens having a field of view with a width of up to about 140 degrees or more, up to about 200 degrees or more, and the like.

According to further aspects, the detection system 34 may further include a second camera 48 having a second field of view 50 different than the first field of view 42. The first field of view 42 may be selected to detect a lower part of the body of the driver 46 of the motor vehicle 20. The second field of view 50 can be selected to detect an upper part of the body of the driver 46 of the motor vehicle 20. For example, the second camera 48 may view at least a head region of the driver 46 such that the image data captured by the camera 48 may be processed by the DSM for determining a gaze direction of the driver, the second camera 48 may view at least a torso region of the driver 46 such that the image data captured by the camera 48 may be processed by the DSM for determining proper use of the seatbelt by the driver 46, and the like.

Referring to FIGS. 1 and 3, the motor vehicle 20 extends longitudinally from a front 52 of the motor vehicle 20 to a rear 54 of the motor vehicle 20 along a longitudinal axis 56. So, according to an aspect, the first camera 40 faces in a first direction (indicated by arrow labeled 57 in FIG. 2) substantially normal to the longitudinal axis 56 (i.e., substantially downward facing) and the second camera 48 faces in a second direction (indicated by arrow labeled 59 in FIG. 2) substantially along the longitudinal axis 56 (i.e., substantially rearward facing or toward the rear 54 of the motor vehicle 20). So, the first camera 40 may be downward facing from the mirror assembly 28 mounted at the upper portion of the windshield 26 for detecting the lower part of body of the driver 46 of the motor vehicle 20. (e.g., hands on steering wheel, center console area, knees, feet, and lower leg area of the driver 46). Such an arrangement of the first camera 40 may allow detection of the lower part (i.e., substantially below the longitudinal axis 56) of the driver 46 now required by new car assessment program (NCAP) rules. The second camera 48 may face rearward to detect the upper part (i.e., substantially above the longitudinal axis 56) of the body of the driver 46 (e.g., face, torso, arms, thighs of the driver 46).

According to further aspects, the controller 44 is further configured to process first driver image data of the driver 46 from the first camera 40 for driver safety monitoring (DSM). In addition, the controller 44 is configured to process second driver image data of the driver 46 from the second camera 48 for the driver safety monitoring. In other words, the DSM system comprised by the detection system 34 may involve monitoring of both the lower and upper parts of the driver 46 while also detecting rain on a surface of at least a portion of the windshield 26.

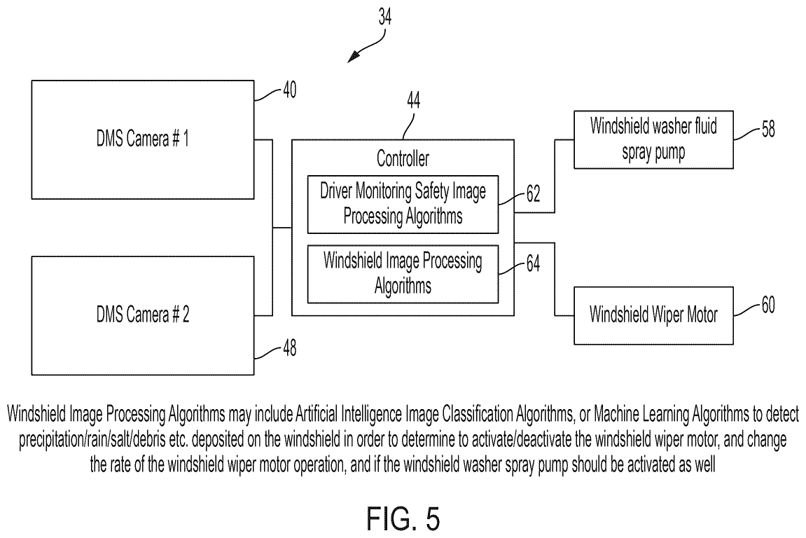

FIG. 5 is a block diagram of the detection system 34. As shown and according to aspects of the disclosure, the controller 44 is in communication with at least one of a windshield washer fluid spray pump 58 or a windshield wiper motor 60 of the motor vehicle 20. The controller 44 also includes driver safety monitoring image processing algorithms 62 for processing the first driver image data and the second driver image data. In addition, the controller 44 includes windshield image processing algorithms 64 for processing the windshield image data. The controller 44 is configured to control the at least one of the windshield washer fluid spray pump 58 or the windshield wiper motor 60 based on the windshield image data processed by the windshield image processing algorithms 64. Furthermore, the windshield image processing algorithms 64 may include artificial intelligence (AI) image classification algorithms and/or machine learning (ML) algorithms to detect precipitation/rain/salt/debris etc. deposited on the windshield 26 in order to determine to activate/deactivate the windshield wiper motor 60, and change the rate of the windshield wiper motor 60 operation, and if the windshield washer spray pump 58 should be activated as well, for example.

In some examples, the system may isolate portions of the image data corresponding to the windshield 26 from portions of the image data corresponding to the driver 46 so that the portions of the image data may be processed separately for detecting presence of rain at the windshield and performing DSM functions. For example, image data captured by the first camera 40 may be processed for sensing rain and for DSM functions and image data captured by the second camera 48 may only be processed for DSM functions. In further examples, only portions of the image data captured by the first camera 40 that are representative of the windshield 26 may be processed for sensing rain and other portions may be processed for DSM functions. For example, the system may determine which portions of the image data are representative of the windshield in first frames of image data and subsequently isolate those portions for rain sensing functions and/or stop processing those portions for DSM functions. Optionally, because the position of the first camera 40 may be relatively stable (with only minor movement when the mirror head is adjusted by the driver), the portions of the image data representative of the windshield and the driver may be predetermined.

Further, the image data captured by the first camera 40 and/or the image data captured by the second camera 48 may be processed for determining a level of ambient light within the cabin of the vehicle, such as to control dimming of the electrochromic mirror reflective element of the mirror assembly 28. For example, only portions of the image data captured by the first camera 40 that are representative of the windshield 26 and/or dashboard region beneath the mirror assembly 28 may be processed for determining the ambient light level.

Thus, although the first camera 40 functions as a DSM camera, the system may isolate image data of the windshield 26 and the controller 44 may process this image data to detect rain on the windshield 26. The spaced back/offset position of the first camera 40 increases the detection area of the windshield 26 compared to a forward looking camera. Also the windshield 26 is more in focus than such a forward looking camera since the focus area of the first camera 40 is in the foot well, which is at a distance that is the same or similar to that of the portion of the windshield 26 being monitored. By expanding the field of view of the first camera 40, the detection system 34 can help comply with NCAP rules that require the inclusion of the lower part of the driver 46, while also enabling the detection of rain on the windshield 26. Thus, the need for a separate rain-light sensor can be removed. The first camera 40 will then be used to detect rain and measure ambient light. A major issue with current camera-based rain sensors is their positioning. As mentioned above, forward-looking cameras are typically placed very close to the windshield 26, making them unable to see rain effectively on the glass of the windshield 26. This leads to unreliable results. By looking directly at the windshield 26, the first camera 40 can accurately detect rainfall. Thus, the system provides improved detection systems that enable rain sensing while reducing complexity and cost while being sufficiently reliable.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from Magna Mirrors of America, Inc. under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

The mirror assembly may include a camera or sensor and/or light emitter of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Pat. Publication No. WO 2025-231198 and/or International PCT Application No. PCT/US2025/038021, filed Jul. 17, 2025 (Attorney Docket DON01 FP5398WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757 and/or U.S. patent application Ser. No. 19/369,638, filed Oct. 27, 2025 (Attorney Docket DON01 P5482), which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Optionally, the DMS camera may be used to detect ambient light and/or glare light (emanating from headlamps of a trailing vehicle) for use in providing auto-dimming of the EC mirror reflective element. The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

The camera includes a lens and imaging sensor. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least two million photosensor elements or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Optionally, image data captured by a rearward-viewing camera (e.g., a rear backup camera or other rearward-viewing camera disposed at a rear portion of the vehicle, or a driver or occupant or cabin monitoring camera that views rearward within the cabin of the vehicle and rearward of the vehicle via a rear window of the vehicle) may be image processed to determine ambient light (and/or glare light) present at the vehicle. Thus, for example, during nighttime driving, image processing of captured image data can be used to appropriately control dimming of the mirror reflective element or the intensity of backlighting of a video display screen to be appropriate for nighttime driving. Also, for example, during high ambient driving, the backlighting is increased so the displayed images are not washed out. The intelligent/automatic mirror dimming functions and/or video display screen dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

Optionally, the mirror assembly (such as at the mounting base, which may be fixed relative to the vehicle windshield) may include an imaging sensor (such as a forward facing imaging sensor or camera that has a forward field of view through the vehicle windshield) that may be part of or may provide an image output for a vehicle vision system, such as a headlamp control system or lane departure warning system or object detection system or other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281 which are hereby incorporated herein by reference in their entireties.

Clearly, changes may be made to what is described and illustrated herein without, however, departing from the scope defined in the accompanying claims. The non-contact obstacle detection system may operate with myriad combinations of various types of non-contact sensors and for any closure members of the motor vehicle, for example. In general, the non-contact obstacle detection system may be used also for other purposes, within the motor vehicle, or for different automotive applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with an example switching system can likewise be implemented into many other systems to control one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular rain sensing system, the vehicular rain sensing system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates a mirror reflective element;
wherein a downward-viewing camera is accommodated by the mirror head, and wherein, with the interior rearview mirror assembly mounted at the interior portion of the interior cabin of the vehicle, the downward-viewing camera views within the interior cabin of the vehicle;
wherein, with the interior rearview mirror assembly mounted at the interior portion of the interior cabin of the vehicle, the downward-viewing camera (i) views through at least a portion of a windshield of the vehicle and (ii) views at least a portion of a driver region of the interior cabin of the vehicle;
wherein the downward-viewing camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle provided by the mirror reflective element;
an electronic control unit (ECU);
wherein image data captured by the downward-viewing camera is transferred to the ECU;
wherein the ECU comprises electronic circuitry and associated software, and wherein the electronic circuitry of the ECU comprises an image processor operable to process image data transferred to the ECU;
wherein, with the interior rearview mirror assembly mounted at the interior portion of the interior cabin of the vehicle, image data captured by the downward-viewing camera that is representative of the view of the portion of the driver region of the interior cabin of the vehicle is processed at the ECU for monitoring the driver region within the interior cabin of the vehicle;
wherein, with the interior rearview mirror assembly mounted at the interior portion of the interior cabin of the vehicle, image data captured by the downward-viewing camera that is representative of the view through the portion of the windshield of the vehicle is processed at the ECU for determining presence of moisture at the windshield of the vehicle; and
wherein, at least in part responsive to determining presence of moisture at the windshield of the vehicle, the vehicular rain sensing system controls operation of at least one selected from the group consisting of (i) a windshield washer fluid spray pump of the vehicle to spray washer fluid onto the windshield of the vehicle and (ii) a windshield wiper motor of the vehicle to move a windshield wiper of the vehicle across the windshield of the vehicle.

2. The vehicular rain sensing system of claim 1, wherein, with the interior rearview mirror assembly mounted at the interior portion of the interior cabin of the vehicle, the downward-viewing camera views a lower body portion of the driver region of the interior cabin of the vehicle.

3. The vehicular rain sensing system of claim 2, wherein a driver-monitoring camera is accommodated by the mirror head, and wherein, with the interior rearview mirror assembly mounted at the interior portion of the interior cabin of the vehicle, the driver-monitoring camera views an upper body portion of the driver region of the interior cabin of the vehicle.

4. The vehicular rain sensing system of claim 3, wherein, with the interior rearview mirror assembly mounted at the interior portion of the interior cabin of the vehicle, the downward-viewing camera views at least downward from the mirror head and the driver-monitoring camera views at least rearward from the mirror head.

5. The vehicular rain sensing system of claim 3, wherein the ECU processes image data captured by the downward-viewing camera and image data captured by the driver-monitoring camera for monitoring the driver region within the interior cabin of the vehicle.

6. The vehicular rain sensing system of claim 1, wherein a first portion of image data captured by the downward-viewing camera is representative of the view through the portion of the windshield of the vehicle, and wherein a second portion of image data captured by the downward-viewing camera is representative of the view of the portion of the driver region of the interior cabin of the vehicle, and wherein, for monitoring the driver region within the interior cabin of the vehicle, the ECU processes the second portion of image data and does not process the first portion of image data.

7. The vehicular rain sensing system of claim 6, wherein, for determining presence of moisture at the windshield of the vehicle, the ECU processes the first portion of image data and does not process the second portion of image data.

8. The vehicular rain sensing system of claim 1, wherein, at least in part based on determining presence of moisture at the windshield of the vehicle, the vehicular rain sensing system controls operation of the windshield wiper motor of the vehicle to move the windshield wiper of the vehicle across the windshield of the vehicle.

9. The vehicular rain sensing system of claim 1, wherein, with the interior rearview mirror assembly mounted at the interior portion of the interior cabin of the vehicle, image data captured by the downward-viewing camera that is representative of the view through the portion of the windshield of the vehicle is processed at the ECU for determining presence of debris at the windshield of the vehicle, and wherein, at least in part based on determining presence of debris at the windshield of the vehicle, the vehicular rain sensing system controls operation of (i) the windshield washer fluid spray pump of the vehicle to spray washer fluid onto the windshield of the vehicle and (ii) the windshield wiper motor of the vehicle to move the windshield wiper of the vehicle across the windshield of the vehicle.

10. The vehicular rain sensing system of claim 1, wherein image data captured by the downward-viewing camera is processed at the ECU for determining a level of ambient light present within the interior cabin of the vehicle.

11. The vehicular rain sensing system of claim 10, wherein the mirror reflective element comprises an electrochromic mirror reflective element, and wherein dimming of the electrochromic mirror reflective element is controlled at least in part based on the determined level of ambient light present within the interior cabin of the vehicle.

12. A vehicular rain sensing system, the vehicular rain sensing system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates a mirror reflective element;
wherein a downward-viewing camera is accommodated by the mirror head, and wherein, with the interior rearview mirror assembly mounted at the interior portion of the interior cabin of the vehicle, the downward-viewing camera views within the interior cabin of the vehicle;
wherein a driver-monitoring camera is accommodated by the mirror head, and wherein, with the interior rearview mirror assembly mounted at the interior portion of the interior cabin of the vehicle, the driver-monitoring camera views within the interior cabin of the vehicle;
wherein, with the interior rearview mirror assembly mounted at the interior portion of the interior cabin of the vehicle, the downward-viewing camera (i) views through at least a portion of a windshield of the vehicle and (ii) views at least a lower body portion of a driver region of the interior cabin of the vehicle;
wherein, with the interior rearview mirror assembly mounted at the interior portion of the interior cabin of the vehicle, the driver-monitoring camera views at least an upper body portion of the driver region of the interior cabin of the vehicle
wherein the downward-viewing camera, the driver-monitoring camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle provided by the mirror reflective element;
an electronic control unit (ECU);
wherein image data captured by the downward-viewing camera is transferred to the ECU, and wherein image data captured by the driver-monitoring camera is transferred to the ECU;
wherein the ECU comprises electronic circuitry and associated software, and wherein the electronic circuitry of the ECU comprises an image processor operable to process image data transferred to the ECU;
wherein, with the interior rearview mirror assembly mounted at the interior portion of the interior cabin of the vehicle, image data captured by the downward-viewing camera that is representative of the view of the lower body portion of the driver region of the interior cabin of the vehicle and image data captured by the driver-monitoring camera that is representative of the view of the upper body portion of the driver region of the interior cabin of the vehicle are processed at the ECU for monitoring the driver region within the interior cabin of the vehicle;
wherein, with the interior rearview mirror assembly mounted at the interior portion of the interior cabin of the vehicle, image data captured by the downward-viewing camera that is representative of the view through the portion of the windshield of the vehicle is processed at the ECU for determining presence of moisture at the windshield of the vehicle; and
wherein, at least in part responsive to determining presence of moisture at the windshield of the vehicle, the vehicular rain sensing system controls operation of at least one selected from the group consisting of (i) a windshield washer fluid spray pump of the vehicle to spray washer fluid onto the windshield of the vehicle and (ii) a windshield wiper motor of the vehicle to move a windshield wiper of the vehicle across the windshield of the vehicle.

13. The vehicular rain sensing system of claim 12, wherein, with the interior rearview mirror assembly mounted at the interior portion of the interior cabin of the vehicle, the downward-viewing camera views at least downward from the mirror head and the driver-monitoring camera views at least rearward from the mirror head.

14. The vehicular rain sensing system of claim 12, wherein a first portion of image data captured by the downward-viewing camera is representative of the view through the portion of the windshield of the vehicle, and wherein a second portion of image data captured by the downward-viewing camera is representative of the view of the lower body portion of the driver region of the interior cabin of the vehicle, and wherein, for monitoring the driver region within the interior cabin of the vehicle, the ECU processes the second portion of image data and does not process the first portion of image data.

15. The vehicular rain sensing system of claim 14, wherein, for determining presence of moisture at the windshield of the vehicle, the ECU processes the first portion of image data and does not process the second portion of image data.

16. The vehicular rain sensing system of claim 12, wherein, at least in part based on determining presence of moisture at the windshield of the vehicle, the vehicular rain sensing system controls operation of the windshield wiper motor of the vehicle to move the windshield wiper of the vehicle across the windshield of the vehicle.

17. The vehicular rain sensing system of claim 12, wherein, with the interior rearview mirror assembly mounted at the interior portion of the interior cabin of the vehicle, image data captured by the downward-viewing camera that is representative of the view through the portion of the windshield of the vehicle is processed at the ECU for determining presence of debris at the windshield of the vehicle, and wherein, at least in part based on determining presence of debris at the windshield of the vehicle, the vehicular rain sensing system controls operation of (i) the windshield washer fluid spray pump of the vehicle to spray washer fluid onto the windshield of the vehicle and (ii) the windshield wiper motor of the vehicle to move the windshield wiper of the vehicle across the windshield of the vehicle.

18. A vehicular rain sensing system, the vehicular rain sensing system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates an electrochromic mirror reflective element;
wherein a downward-viewing camera is accommodated by the mirror head, and wherein, with the interior rearview mirror assembly mounted at the interior portion of the interior cabin of the vehicle, the downward-viewing camera views within the interior cabin of the vehicle;
wherein, with the interior rearview mirror assembly mounted at the interior portion of the interior cabin of the vehicle, the downward-viewing camera (i) views through at least a portion of a windshield of the vehicle and (ii) views at least a portion of a driver region of the interior cabin of the vehicle;
wherein the downward-viewing camera and the electrochromic mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle provided by the electrochromic mirror reflective element;
an electronic control unit (ECU);
wherein image data captured by the downward-viewing camera is transferred to the ECU;
wherein the ECU comprises electronic circuitry and associated software, and wherein the electronic circuitry of the ECU comprises an image processor operable to process image data transferred to the ECU;
wherein image data captured by the downward-viewing camera is processed at the ECU for determining a level of ambient light present within the interior cabin of the vehicle;
wherein dimming of the electrochromic mirror reflective element is controlled at least in part based on the determined level of ambient light present within the interior cabin of the vehicle;
wherein a first portion of image data captured by the downward-viewing camera is representative of the view through the portion of the windshield of the vehicle, and wherein a second portion of image data captured by the downward-viewing camera is representative of the view of the portion of the driver region of the interior cabin of the vehicle;
wherein, with the interior rearview mirror assembly mounted at the interior portion of the interior cabin of the vehicle, (i) the second portion of image data is processed at the ECU for monitoring the driver region within the interior cabin of the vehicle and (ii) the first portion of image data is not processed at the ECU for monitoring the driver region within the interior cabin of the vehicle;
wherein, with the interior rearview mirror assembly mounted at the interior portion of the interior cabin of the vehicle, (i) the first portion of image data is processed at the ECU for determining presence of moisture at the windshield of the vehicle and (ii) the second portion of image data is not processed at the ECU for determining presence of moisture at the windshield of the vehicle; and
wherein, at least in part responsive to determining presence of moisture at the windshield of the vehicle, the vehicular rain sensing system controls operation of at least one selected from the group consisting of (i) a windshield washer fluid spray pump of the vehicle to spray washer fluid onto the windshield of the vehicle and (ii) a windshield wiper motor of the vehicle to move a windshield wiper of the vehicle across the windshield of the vehicle.

19. The vehicular rain sensing system of claim 18, wherein, at least in part based on determining presence of moisture at the windshield of the vehicle, the vehicular rain sensing system controls operation of the windshield wiper motor of the vehicle to move the windshield wiper of the vehicle across the windshield of the vehicle.

20. The vehicular rain sensing system of claim 18, wherein, with the interior rearview mirror assembly mounted at the interior portion of the interior cabin of the vehicle, (a) the first portion of image data is processed at the ECU for determining presence of debris at the windshield of the vehicle and (b) the second portion of image data is not processed at the ECU for determining presence of debris at the windshield of the vehicle, and wherein, at least in part based on determining presence of debris at the windshield of the vehicle, the vehicular rain sensing system controls operation of (i) the windshield washer fluid spray pump of the vehicle to spray washer fluid onto the windshield of the vehicle and (ii) the windshield wiper motor of the vehicle to move the windshield wiper of the vehicle across the windshield of the vehicle.
